(19) United States
(12) Patent Application Publication
(10) Pub. No.: US 2017/0123636 A1
(43) Pub. Date: May 4, 2017

(54) METHOD AND APPARATUS FOR MORPHING AND POSITIONING OBJECTS ON A TOUCH-SCREEN DEVICE TO AIDE IN ONE-HANDED USE OF THE DEVICE

(71) Applicant: MOTOROLA SOLUTIONS, INC, SCHAUMBURG, IL (US)

(72) Inventors: Sze Wan Lim, Pulau Pinang (MY); Yew Choon Chong, Georgetown (MY); Yin Thong Choong, Prai (MY); Chee Hoe Hui, Penang (MY); Marilyn Chien Hui Lim, Penang (MY); Mun Yew Tham, Bayan Lepas (MY)

(21) Appl. No.: 14/930,765

(22) Filed: Nov. 3, 2015

(51) Int. Cl. G06F 3/0484; G06T 3/00; G06T 3/40; G06F 3/01; G06F 3/0488; G06F 3/0481

(52) U.S. Cl. CPC G06F 3/04845; G06F 3/04883; G06F 3/04817; G06T 3/40; G06F 3/017; G06T 3/0093

(57) ABSTRACT

A method and apparatus for morphing and/or positioning objects on a touch-screen device to aide in one handed use of the device is provided herein. During operation, the device will detect a tilt of the device, and morph/orient user-interface objects on the touch screen based on the tilt of the device. Positioning and/or morphing user-interface objects based on the device's tilt will allow the user to better position the user-interface objects for one-handed operation.

### FIELD OF THE INVENTION

The present invention generally relates to morphing and/or positioning objects on a touch-screen device, and in particular to morphing and/or positioning objects on a touch-screen device to aide in one handed use of the device.

### BACKGROUND OF THE INVENTION

Almost half of all touch screen users tend to use one hand to operate the device. It is known to place items on a touch-screen in order to accommodate one-handed operation. For example, US Publication No. 2014/0101593 describes the placement of items on a touch screen so that a user may have an easier time operating the device with one hand. The placement of items on a touch screen to accommodate one-handed operation is based on whether or not the one-handed use of the touch screen will be with a user's right or left hand. For example, if a person is using their touch-screen device with their right hand, important items on the screen may be shifted to the first area of the touch screen. If a person is using their touch-screen device with their left hand, those important items may be shifted to a second area of the touch screen.

A problem exists with one-handed operation of a device when, for example, a touch-screen device operates in a one-handed mode that is opposite to the hand a user is actually operating the device with. For example, if a device is operating in a one-handed mode for right-hand operation (i.e., items shifted to the first area of the screen), the user will find the device difficult to operate if they are using the device solely with their left hand. Consider the case where a right-handed police officer is operating a touch-screen device with their right hand only. The device may operate in a mode that shifts items to the first area of the screen. If the officer pulls their gun with their right hand, operation of their device (if needed) will most certainly take place using their left hand, as the gun will be held in the officer's right hand. Having the device operating in a right-hand mode while holding the device in their left hand will make operation of the device difficult. Therefore, a need exists for a method and apparatus positioning objects on a touch-screen device to aide in one handed use of the device.

### BRIEF DESCRIPTION OF THE SEVERAL VIEWS OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention.

FIG. 1 illustrates one-handed use of a device.

FIG. 2 illustrates determining a component of acceleration along a touch screen.

FIG. 3 illustrates morphing and/or positioning of interface elements.

FIG. 4 illustrates morphing and/or positioning of interface elements.

FIG. 5 illustrates morphing and/or positioning of interface elements.

FIG. 6 illustrates morphing and/or positioning of interface elements.

FIG. 7 illustrates morphing and/or positioning of interface elements.

FIG. 8 illustrates morphing and/or positioning of interface elements.

FIG. 9 is a block diagram of a touch-screen device.

FIG. 10 is a flow chart showing operation of the touch-screen device of

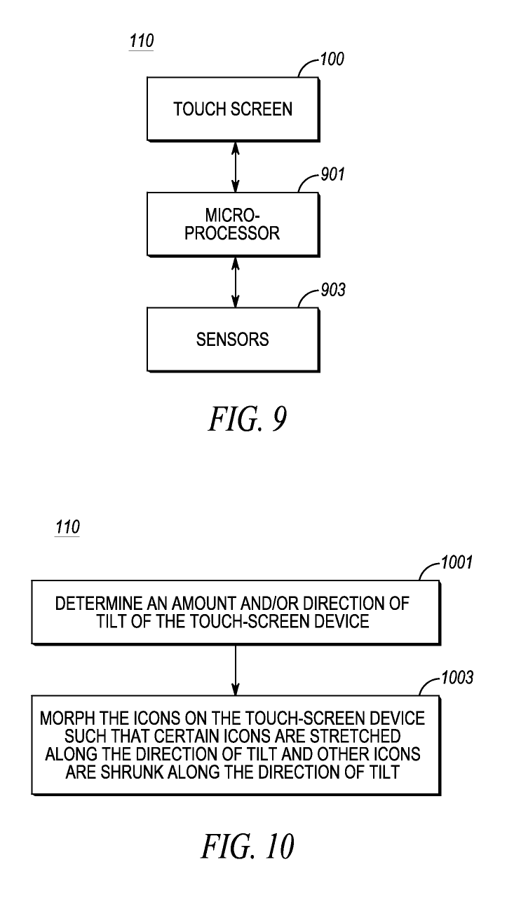

FIG. 9.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required.

### DETAILED DESCRIPTION

In order to address the above, mentioned need, a method and apparatus for morphing and/or positioning objects on a touch-screen device to aide in one handed use of the device is provided herein. During operation, the device will detect a tilt of the device, and morph and/or position user-interface objects on the touch screen based on the tilt of the device. Positioning and/or morphing user-interface objects based on the device's tilt will allow the user to better position the user-interface objects for one-handed operation.

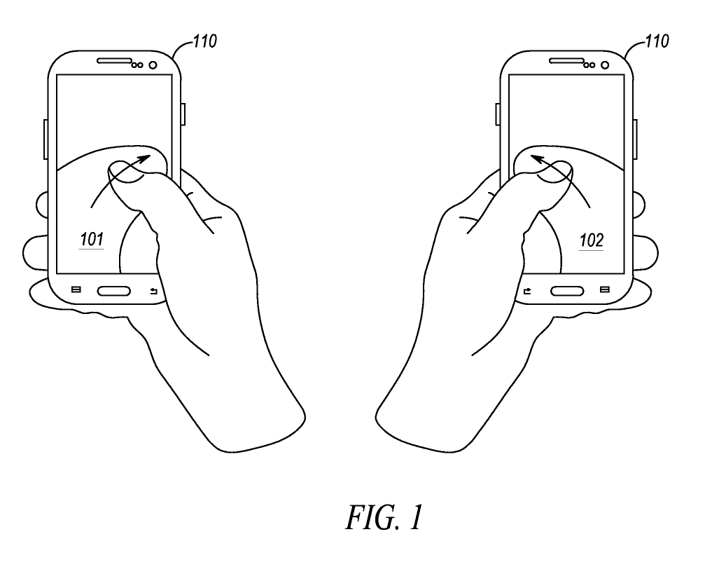

As an example of the above, consider the case where a right-handed police officer is operating a touch-screen device with their right hand only. The device may operate with user-interface objects shifted to the first area of the screen. If the officer pulls their gun with their right hand, operation of their device (if needed) will then take place using their left hand. By tilting the device, the officer can shift or morph the interface objects to aide in left-handed operation of the device. The officer may then interact with the device by contacting the touch screen at locations corresponding to the user-interface objects with which they wish to interact. This is illustrated in FIG. 1.

As shown in FIG. 1, when device 110 is operating for right-handed use, the user will preferably morph and/or position important interface objects (e.g., icons, buttons, soft keys, menus, buttons, knobs, and other user-interface elements) within a first area 101. When the user is operating device 110 for left-handed use, the user will preferably morph and/or position important interface items within a second, differing area 102. It should be noted, that the first area and the second area may be mutually exclusive (e.g., non-overlapping) or may overlap. As is evident, first area 101 occupies a different region of the touch screen than second area 102. As one of ordinary skill in the art will recognize, a normal mode of operation (normal handedness) will have no handed preference to the placement of objects on the touch screen.

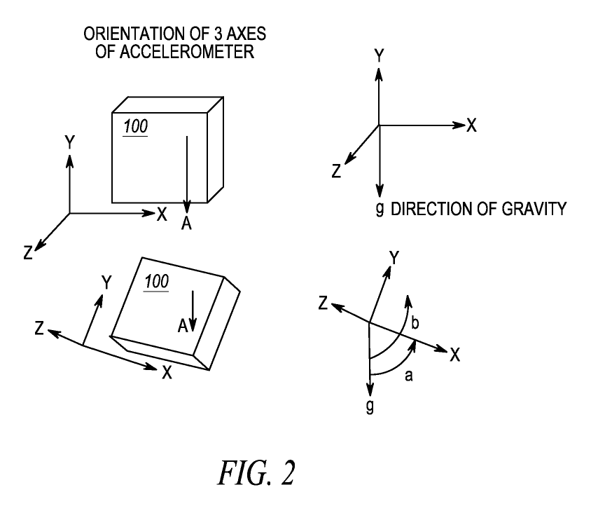

As discussed above, a morphing and/or positioning of interface objects will be based on an amount of tilt of device 110. More particularly, device 110 is equipped with three accelerometers to detect acceleration. A component of acceleration along touch screen 100 is determined and interface objects are positioned and/or morphed accordingly. This is illustrated in FIG. 2.

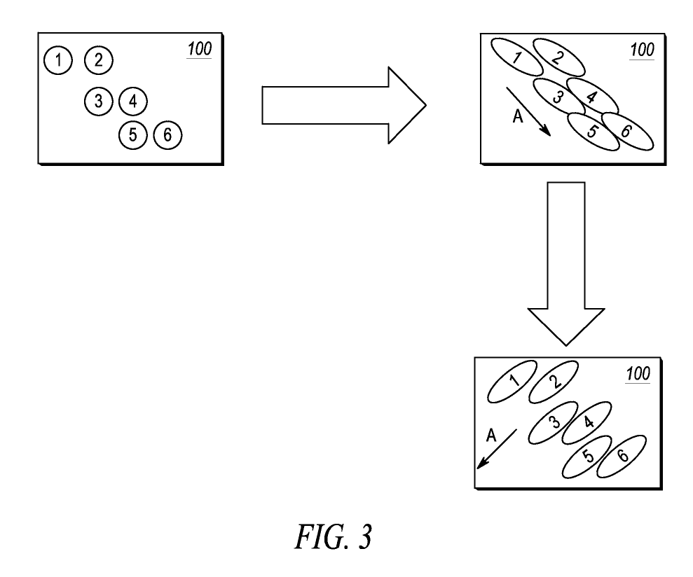

As shown in FIG. 2, touch screen 100 may take on any number of orientations. Consider an x, y, and z axis are oriented as shown in FIG. 2. The x and y axes exist parallel to the edges of touch screen 100 while the z axis is shown perpendicular to touch screen 100. A component of acceleration along the x and y directions (due to gravity (g)) can be determined. Referring to FIG. 2, the component of acceleration (g) along the x axis is gCOS(a) and the component of acceleration (g) along the y axis is gCOS(b). The component of acceleration (A) along the xy plane (face of the touch screen) is simply A=gCOS(a)+gCOS(b). Vector A is utilized by device 110 in determining how to position and/or morph user interface objects. This is illustrated in FIG. 3 through FIG. 0.

The feature of morphing and/or positioning interface objects may be activated and inactivated by any number of user actions. In one embodiment activation takes place by a long press to the touch screen. Inactivation freezes the interface objects in place. Inactivation may take place by any number of user actions. In one embodiment of the present invention, inactivation takes place by the user performing a swipe across the touch screen.

Referring to FIG. 3, user interface objects 1-6 existing on touch screen 100 may be morphed (e.g., change smoothly from one image to another by small gradual steps using computer animation techniques, or undergo a gradual process of transformation from one shape to another) based on a magnitude and direction of A. In this particular example, user interface objects 1-6 are stretched in the direction of A. The speed in which they are stretched is directly proportional to the magnitude of A so that as the magnitude of A increases, the rate at which interface objects 1-6 are stretched increases, and vice versa. Interface objects 1-6 may continue to morph as the direction and magnitude of A changes until a maximum amount of morphing takes place. As illustrated in FIG. 3, stretching may take place originally from the upper left of touch screen 100 to the lower right of touch screen 100, and as A shifts, the direction in which interface objects 1-6 are shifted may change as well.

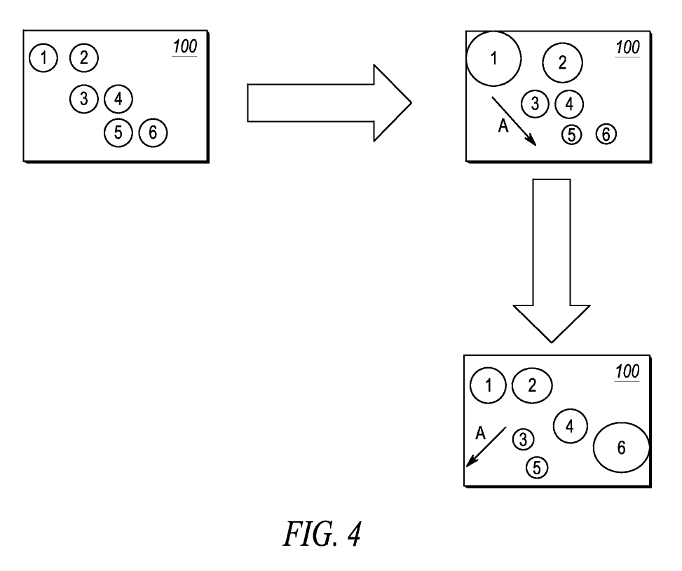

Referring to FIG. 4, user interface objects 1-6 existing on touch screen 100 may be morphed (e.g., change smoothly from one image to another by small gradual steps using computer animation techniques, or undergo a gradual process of transformation from one shape to another) based on a magnitude and direction of A. In this particular example, user interface objects 1-6 are increased in size based on a direction of A. More particularly, if vector A defines an axis with a positive direction along the direction of A, those interface objects with higher positive values have a size that is inversely proportional to their value along the A axis. As shown in FIG. 4, interface objects 1-6 are morphed with their size inversely proportional to their value along the A axis. Again, the speed in which they are morphed is directly proportional to the magnitude of A so that as the magnitude of A increases, the rate at which interface objects 1-6 are re-sized increases, and vice versa. Interface objects 1-6 may continue to morph as the direction and magnitude of A changes. As illustrated in FIG. 4, resizing may take place as A shifts.

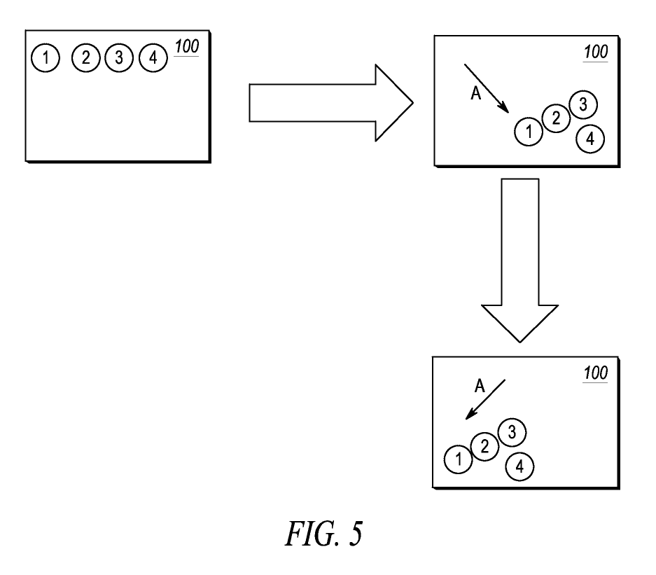

Referring to FIG. 5, user interface objects 1-6 existing on touch screen 100 may be moved (e.g., repositioned smoothly from one position on touch screen 100 to another by small gradual steps using computer animation techniques) based on a magnitude and direction of A. In this particular example, user interface objects 1-6 are moved in the direction of A. The speed in which they are moved is directly proportional to the magnitude of A so that as the magnitude of A increases, the rate at which interface objects 1-6 are moved increases, and vice versa. Interface objects 1-6 may continue to move as the direction and magnitude of A changes. As illustrated in FIG. 5, movement may take place originally from the upper left of touch screen 100 to the lower right of touch screen 100, and as A shifts, the direction in which interface objects 1-6 are moved may change as well. In this particular embodiment, interface objects are positioned so that no interface object will overlap each other.

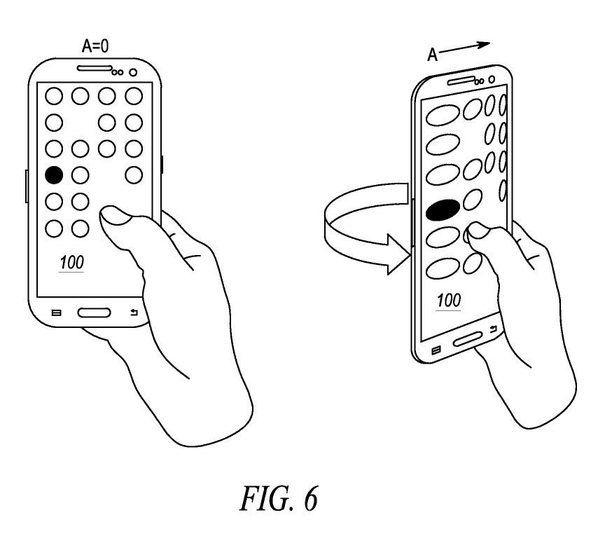

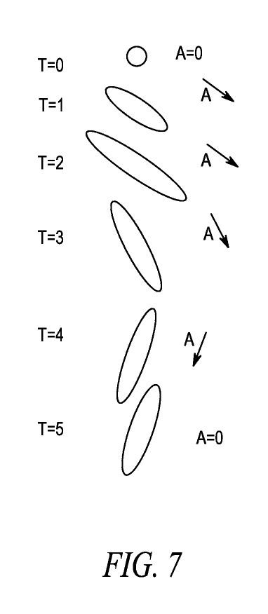

Referring to FIG. 6, user interface objects (represented as circles and ovals on touch screen 100) may be morphed (e.g., change smoothly from one image to another by small gradual steps using computer animation techniques, or undergo a gradual process of transformation from one shape to another) based on a magnitude and direction of A. In this particular example, user interface objects are stretched with a magnitude of stretching based on a direction of A. More particularly, if vector A defines an axis with a positive direction along the direction of A, those interface objects with higher positive values have a magnitude of stretching that is inversely proportional to their value along the A axis. As shown in FIG. 6, interface objects are morphed with their magnitude of stretching inversely proportional to their value along the A axis. Again, the speed in which they are morphed is directly proportional to the magnitude of A so that as the magnitude of A increases, the rate at which interface objects are re-sized increases, and vice versa. Interface objects may continue to morph as the direction and magnitude of A changes. As illustrated in FIG. 7, resizing may take place as A shifts.

Referring to FIG. 7 at t=0, A=0 and no morphing of the interface object takes place. t=0, A increases and the interface object is morphed (stretched) in a direction of A. At t=1, the value and direction of A remains unchanged from t=1 and morphing continues until a maximum amount of morphing is reached. At t=3,the direction of A changes, and the interface object is rotated along the new direction of A. This rotation continues at t=4 with the interface object rotating accordingly. At t=5, A=0 and no continued morphing of the interface object takes place.

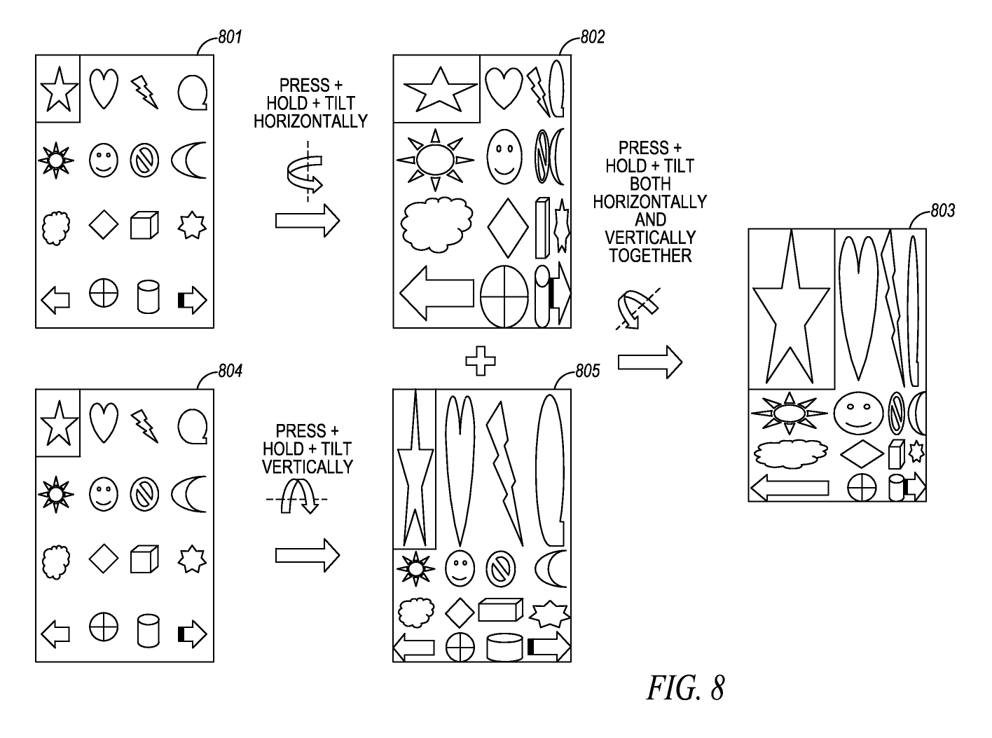

FIG. 8 shows morphing user interface objects in accordance with one embodiment of the present invention. As discussed, icons or user interface objects may exist on screen 801 prepositioned in a predetermined area of the screen. A user may activate the morphing feature by a long press on touch screen 801. Once activated, as the device tilts, interface objects will be stretched/morphed accordingly. This is illustrated in the icons on screen 802 being stretched and shrunk in the horizontal direction as the device it tilted horizontally. The device may continue to be tilted with a vertical component and the icons/interface objects may continue to be stretched and shrunk in the direction of tilt. As is evident, assuming that vector A defines an axis, those icons that are more negative along the A axis will have their size increased, while those icons having a more positive along the A axis will have their size decreased. Those icons having an intermediary value (as compared to the values of other icons) along the A axis will remain somewhat the same size. As is also evident, icons are increased and decreased in size by stretching and shrinking the icons in the direction of A.

Similarly, icons on screen 804 are stretched and shrunk as shown on screen 805 as the device tilts vertically. If the device tilts in a horizontal direction, the icons continue to be stretched and shrunk along a horizontal direction.

FIG. 9 is a block diagram of touch-screen device 110. Touch-screen device 110 may be any suitable computing device with one or more local sensor 903. Touch-screen device 110 will be configured to determine to change in tilt of device 110 and position and/or morph interface objects as described above. Touch-screen device 110 may comprise a cellular telephone, a two-way radio, a personal-digital assistant, a laptop computer, or any other device having a touch screen (or touch pad) that is capable of being operated with a single hand.

Preferably, sensors 903 may comprise any device capable of generating a current tilt of device 110. For example, sensors 903 may comprise accelerometers capable of determining a magnitude of g along an x and y axis of device 110. However, sensors 903 may alternatively comprise level detectors, a vision system, an eye detection system, or any other system/circuitry that will indicate a tilt of device 110.

Logic circuitry 901 comprises a digital signal processor (DSP), general purpose microprocessor, a programmable logic device, or application specific integrated circuit (ASIC) and is configured to determine an amount to move and/or morph interface objects based on a tilt of device 110.

FIG. 9 provides for an apparatus comprising a sensor outputting an amount of tilt of a touch-screen device, and logic circuitry receiving the amount of tilt and outputting instructions to morph icons on the touch-screen device such that certain icons are stretched along the direction of tilt and other icons are shrunk along the direction of tilt.

The amount of tilt may be based on a vector A along a surface of the touch screen. The logic circuitry then determines a value for each icon along a direction of A and outputs instructions to morph the icons based on the value for each icon along the direction of A such that some icons are increased in size along the direction of A and some icons are decreased in size along the direction of A. The vector A may comprise a component of gravity along the surface of the touch screen.

FIG. 10 is a flow chart showing operation of the device of FIG. 9. More particularly, the logic flow of FIG. 10 illustrates those steps (not all necessary) for morphing icons on a touch-screen device. The logic flow begins at step 1001 where sensors 903 determine an amount and/or direction of tilt of the touch-screen device and provides this information to logic circuitry 901. At step 1003 logic circuitry 901 instructs touch screen 100 to morph the icons on the touch-screen device such that certain icons are stretched along the direction of tilt and other icons are shrunk along the direction of tilt.

As discussed above, a long press on the touch-screen may be received to activate the step of morphing and a swipe may be received on the touch-screen to inactivate the step of morphing. Additionally, the step of determining the amount of tilt may comprise the step of determining a vector A along a surface of the touch screen. The step of morphing may comprise determining a value for each icon along a direction of A and morphing the icons based on the value for each icon along the direction of A such that some icons are increased in size along the direction of A and some icons are decreased in size along the direction of A. The vector A comprises a component of gravity along the surface of the touch screen.

In the foregoing specification, specific embodiments have been described. However, one of ordinary skill in the art appreciates that various modifications and changes can be made without departing from the scope of the invention as set forth in the claims below. For example, although the above embodiment was described with interface objects being moved or morphed based on a tilt of device 110, interface objects may be both moved and morphed based on the tilt.

Those skilled in the art will further recognize that references to specific implementation embodiments such as “circuitry” may equally be accomplished via either on general purpose computing apparatus (e.g., CPU) or specialized processing apparatus (e.g., DSP) executing software instructions stored in non-transitory computer-readable memory. It will also be understood that the terms and expressions used herein have the ordinary technical meaning as is accorded to such terms and expressions by persons skilled in the technical field as set forth above except where different specific meanings have otherwise been set forth herein.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method of morphing icons on a touch-screen device, the method comprising the steps of:
determining a direction of tilt of the touch-screen device;
morphing the icons on the touch-screen device such that certain icons have their shape changed by stretching the certain icons along the direction of tilt.

2. The method of claim 1 further comprising the step of:
in addition to stretching the certain icons along the direction of tilt, changing the shape of other icons by shrinking the other icons along the direction of tilt.

3. The method of claim 2 further comprising the step of:
receiving a swipe on the touch-screen to inactivate the step of morphing.

4. The method of claim 1 further comprising the step of determining an amount of tilt.

5. The method of claim 4 the step of determining the amount of tilt comprises the step of determining a vector A along a surface of the touch screen, and wherein the step of morphing comprises the steps of:
determining a value for each icon along a direction of A; and
morphing the icons based on the value for each icon along the direction of A such that some icons are increased in size along the direction of A and some icons are decreased in size along the direction of A.

6. The method of claim 4 wherein the vector A comprises a component of gravity along the surface of the touch screen.

7. An apparatus comprising:
a sensor outputting an amount of tilt of a touch-screen device;
logic circuitry receiving the amount of tilt and outputting instructions to morph icons on the touch-screen device such that certain icons have their shape changed by stretching the certain icons along the direction of tilt and other icons have their shape changed by shrinking the other icons along the direction of tilt.

8. The apparatus of claim 7 wherein the amount of tilt is based on a vector A along a surface of the touch screen.

9. The apparatus of claim 8 wherein the logic circuitry determines a value for each icon along a direction of A and outputs instructions to morph the icons based on the value for each icon along the direction of A such that some icons are increased in size along the direction of A and some icons are decreased in size along the direction of A.

10. The apparatus of claim 8 wherein the vector A comprises a component of gravity along the surface of the touch screen.
